(19) United States
(12) Patent Application Publication
(10) Pub. No.: US 2016/0342639 A1
(43) Pub. Date: Nov. 24, 2016

(54) METHODS AND SYSTEMS FOR GENERATING SPECIALIZED INDEXES OF RECORDED MEETINGS

(71) Applicant: Polycom, Inc., San Jose, CA (US)

(72) Inventors: Dragan Ignjatic, Belgrade (RS); John Raymond Nicol, Framingham, MA (US)

(21) Appl. No.: 15/160,679

(22) Filed: May 20, 2016

Related U.S. Application Data
(60) Provisional application No. 62/164,362, filed on May 20, 2015.

(51) Int. Cl. G06F 17/30

(52) U.S. Cl. CPC G06F 17/30336; G06F 17/30598; G06F 17/30569

(57) ABSTRACT

Disclosed are systems and methods for creating indexes of recorded meetings, and particularly for creating refined indexes of recorded meeting. By way of example only, the system can record a meeting and create a starting index for the meeting based on keyword spotting. The system can also detect events that occur during the meeting that may reflect topic changes. The starting index can then be updated to reflect the topic changes to create a more useful and condensed meeting index.

### CROSS-REFERENCES TO RELATED APPLICATIONS

This application claims priority to U.S. provisional patent application No. 62/164,362, filed on May 20, 2015, which is incorporated by reference herein in its entirety.

### FIELD OF THE DISCLOSURE

This disclosure relates to creating specialized indexes for recorded meetings. As an example, specialized indexes can be indexes that are created based on identifying topic shifts in a recorded meeting.

### BACKGROUND

Business environments often include frequent meetings between personnel. Historically the substance and content of these meetings was either not preserved at all or was preserved only at a somewhat high level, such as written minutes of a meeting or various notes taken by the participants. This has often led to a variety of inefficiencies and other sub-optimal results because the participants may not remember what transpired in sufficient detail and/or because non-participants who might have need to know what was discussed or decided might not have access to sufficiently detailed records of what was actually discussed. In the modern business environment, the wide proliferation of relatively unobtrusive and easy to use recording technologies has allowed meetings to be recorded in their entirety. These recording technologies include telephone and videoconferencing systems with integrated or optional recording capabilities and “wired” rooms that allow live meetings to be recorded. Digital implementations of such systems and the sharp increases in computerized storage capabilities have created an environment in which many meetings and other conversations can be recorded and archived for future reference. Unfortunately, recorded meetings, including video conferences, audio conferences, phone calls, etc. have in some ways become the “black holes” of organizational information management and analysis strategy. Because of the sheer number and size of the conversations and the duration of recordings, and because of the difficulty in locating the discussion of specific items within the conversations, it has been practically difficult to go back and obtain useful information from these recorded conversations in a timely manner.

It would be useful to extract topical information from content shared during a meeting. However, existing systems have limited ability to extract such information from content. Some solutions, for example HarQen™, have attempted to support some human-driven analytics capability that allows participants to “mark” interesting spots in a conversation for later consumption. The problem with this approach is that it requires humans to mark the sections (practically speaking most users will choose not to invest the effort to perform manual operations such as this), and it is often difficult to know during the call what will be important later. Some systems have been able to generate transcripts or perform word-spotting (displaying spotted words as points on a timeline). But such techniques suffer from the drawback of being unable to correlate these with contextual cues other than the relative time they occurred in the conversation.

One solution to the afore-mentioned “black hole” problem is to transform a recorded meeting to a text record, and then create an index from the text record that can later be searched by a user. For example, FIG. 1 illustrates a conventional video conferencing architecture. Endpoint A (EP A) 110 and Endpoint B (EP B) 120 can initiate a video conferencing session through a server engine 100. The server engine 100 can be any typical server, and can include, among other things, a network interface 130, any number of I/O devices 140, a processor 150, and a memory 190. These components can be interconnected via a communications bus 195. A video conferencing session between EP A 110 and EP B 120 can be recorded by a recording module 185. The server engine 100 may also include an indexing engine 170 that indexes the recordings from the recorded meeting. At a high level, the indexing engine can translate the recordings of a video conferencing session (or teleconferencing session) to text. For example, the indexing engine 170 can use well known speech-to-text engines to convert speech to text. The server 100 or the indexing engine can also include an analyzer 180 that can identify keywords from the text such that non-essential words (e.g., “a”, “of”, “the” etc.) are excluded from the indexing process. The indexing engine 170 can ultimately index the translated meeting. For example, keywords can be alphabetized and associated with a particular time reference. A user can later search the index for keywords to identify and review particular segments of the meeting.

While current indexing technology is somewhat useful, there remains a number of drawbacks. Today's best speech to text (STT) engines exhibit very high complexity and relatively long latency. Thus, transforming a recorded meeting to text imposes a large load on the server. And despite the computational and latency overhead costs associated with speech to text technology, accuracy results are typically below 90%. Furthermore, an index for any one recorded meeting can typically be quite large. Creating and searching through such large indexes also imposes a significant load on the server. These large indexes also include a number of false positives, rendering them cumbersome to search and less useful to a user. For example, a keyword may be indexed for a particular segment of the meeting because the keyword was mentioned, but that particular segment of the meeting may not be focused on the keyword.

Thus, there is a need in the art for a more reliable and accurate way of indexing recorded conversations.

### SUMMARY OF THE INVENTION

Disclosed herein is a system and method for creating specialized indexes of recorded meetings. By way of example only, a specialized index is created based on detecting topic shifts in a recorded meeting.

In one embodiment, a system associated with a meeting can create a starting index based on meeting data. The system can record data streams during the meeting and detect navigation events, which may indicate interest in a particular topic. Recorded data streams associated with a navigation event can be converted to text and evaluated against the starting index. If there is a match between the converted text and text in the starting index, the navigation event can be considered a topic shift. The system can then update/condense the starting index to reflect the topic shift. In this way, a more specialized and condensed index can be created for a particular meeting.

### BRIEF DESCRIPTION OF THE DRAWINGS

The foregoing summary, as well as the following detailed description, will be better understood when read in conjunction with the appended drawings. For the purpose of illustration only, there is shown in the drawings certain embodiments. It's understood, however, that the inventive concepts disclosed herein are not limited to the precise arrangements and instrumentalities shown in the figures.

FIG. 1 shows a prior art video conferencing architecture.

FIG. 2 shows a video conferencing architecture, in accordance with an embodiment.

FIG. 3 illustrates a flow diagram for creating a specialized index, in accordance with an embodiment.

### DETAILED DESCRIPTION

Meetings can take place in a variety of ways, including via audio, video, presentations, chat transcripts, shared documents and the like. Those meetings can be at least partially recorded by any type of recording source, including but not limited to a telephone, a video recorder, an audio recorder, a videoconferencing endpoint, a telephone bridge, a videoconferencing multipoint control unit, network server or other source. This disclosure is generally directed to systems, methods, and computer readable media for indexing such recorded meetings. In general, the application discloses techniques for creating specialized indexes of recorded meetings on end user devices. These specialized indexes are condensed versions of conventional indexes that are based on topic shifts in a recorded meeting. This technique can ultimately redistribute the indexing load typically imposed on a server to end user devices.

The embodiments described herein are discussed in the context of a video conference architecture. However, the embodiments can just as easily be implemented in the context of any meeting architecture, including architectures involving any of the afore-mentioned technologies that can be used to record meetings.

Before explaining at least one embodiment in detail, it should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting.

It should further be understood that any one of the described features may be used separately or in combination with other features. Other invented systems, methods, features, and advantages will be or become apparent to one with skill in the art upon examining the drawings and the detailed description herein. It's intended that all such additional systems, methods, features, and advantages be protected by the accompanying claims.

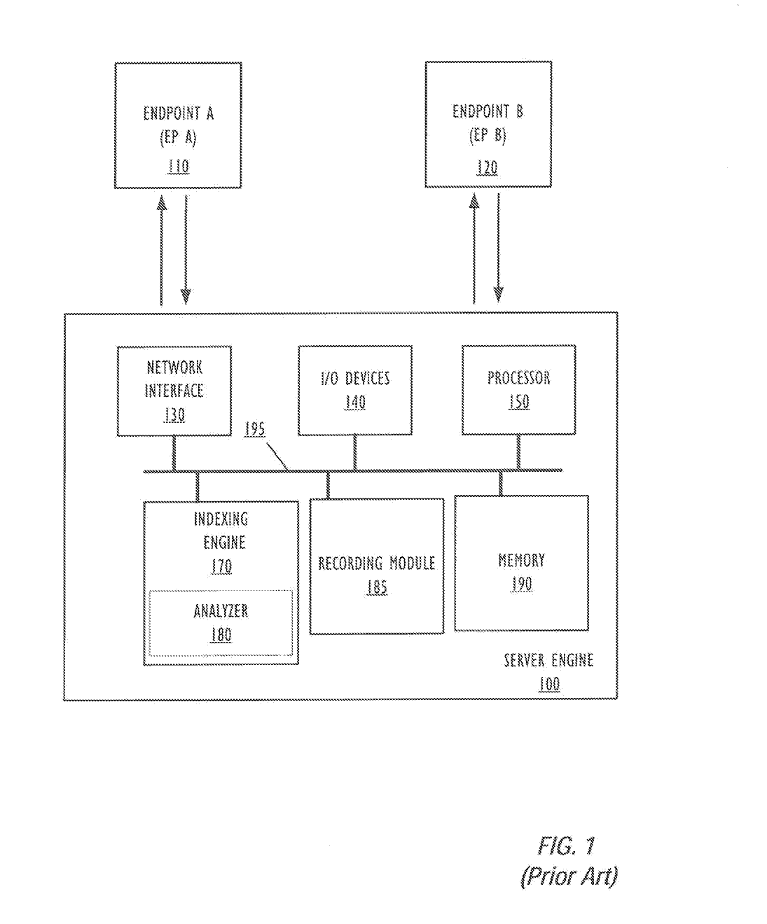

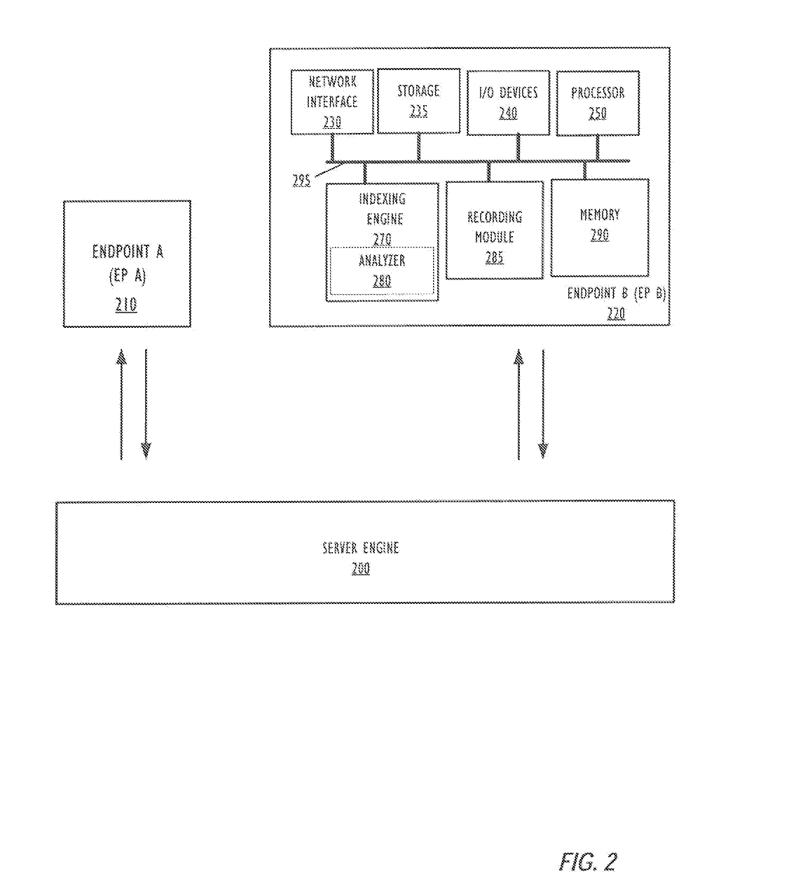

FIG. 2, by way of example only, illustrates a video conferencing architecture in accordance with the embodiments described herein. Endpoint A 210 and Endpoint B can participate in a video conferencing session via server engine 200. Server engine 200 can include one or more of the components illustrated in the server engine 100 of FIG. 1. The endpoints can be any type of electronic device, including but not limited to a personal digital assistant (PDA), personal music player, desktop computer, mobile telephone, notebook, laptop, tablet computer, or any other similar device.

EP B 220 is shown in greater detail, and the contents of EP B 210 may also be included in EP A 210 and any other endpoint involved in the video conference. As depicted, EP B 220 includes various components connected across a bus 295. The various components include a processor 250, which controls the operation of the various components of EP B 220. Processor 250 can be a microprocessor, microcontroller, a field programmable gate array (FPGA), an application specific integrated circuit (ASIC), or a combination thereof. Processor 250 can be coupled to a memory 290, which can be volatile (e.g., RAM) or non-volatile (e.g., ROM, FLASH, hard-disk drive, etc.). Storage 235 may also store all or portion of the software and data associated with EP B 210. In one or more embodiments, storage 235 includes non-volatile memory (e.g., ROM, FLASH, hard-disk drive, etc.). Storage 235 may store media (e.g., audio, image and video files), computer program instructions or software, preference information, device profile information, and any other suitable data. Storage 235 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 290 and storage 235 may be used to tangibly retain computer program instructions or code organized into one or more modules and written in any desired computer programming language. When executed by processor 250 such computer program code may implement one or more of the methods described herein.

EP B 220 can further include additional components, such as a network interface 230, which may allow EP B 220 to communicably connect to remote devices, such as EP A 210 and server engine 200. That is, in one or more embodiments, EP A 210 and EP B 220 and server engine 200 can be connected across a network, such as a packet switched network, a circuit switched network, an IP network, or any combination thereof. The multimedia communication over the network can be based on protocols such as, but not limited to, H.320, H.323, SIP, HTTP, HTML5 (e.g. WebSockets, REST), SDP, and may use media compression standards such as, but not limited to, H.263, H.264, VP8, G.711, G.719, and Opus. HTTP stands for Hypertext Transfer Protocol and HTML stands for Hypertext Markup Language. Further protocols may include Session Initiation Protocol (“SIP”) or Session Description Protocol (“SDP”).

EP B 220 can also include various I/O devices 240 that allow a user to exchange media with EP B 220. The various I/O devices 240 may include, for example, one or more of a speaker, a microphone, a camera, and a display that allow a user to send and receive data streams. Thus, EP B 220 may generate data streams to transmit to EP A 210 and server engine 200 by receiving audio or video signals through the various I/O devices 240. EP B 220 may also present received data signals to a user using the various I/O devices 240. I/O devices 240 may also include a keyboard and a mouse such that a user may interact with a user interface displayed on a display device to manage content shared during a collaboration session.

In one embodiment, EP B 220 also includes a recording module 285 and an indexing engine 270. The software necessary to operate the recording module 285 and the indexing module 270 can be stored in storage 235. The recording module 285 can record the collaboration session (e.g., video/audio conferencing session) between the endpoints. In another embodiment, the recording module may instead be housed in the server engine 200. The indexing engine 270 can be configured to index meetings recorded by the recording module 285. For example, in one embodiment, the indexing engine 270 can use speech-to-text software that can convert speech recorded during the collaboration session to text. The indexing engine can also include an analyzer 280 that can identify keywords from the text so that non-critical words (e.g., “a”, “of”, “the” etc.) are excluded from the indexing process. The indexing engine 270 can then index the recorded meeting. In one embodiment, the index can be stored locally in memory 290 or storage 235. In another embodiment, the index can be sent to and stored in the server engine 200. An end user at EP B 220 can then search this index locally. In another embodiment, the index can be transferred from EP B 220 to the server engine. The index is then accessible for searching by both EP B 220 and EP A 210. In this way, the load for creating and/or searching an index can be transferred from the conventional server engine 200 to an endpoint.

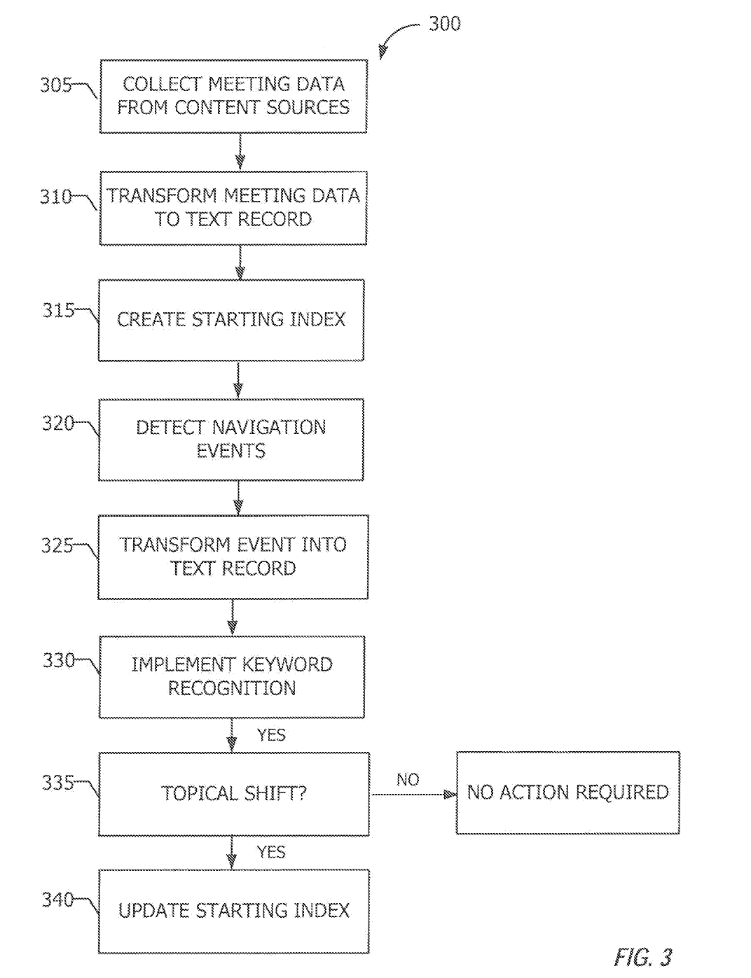

In an embodiment, indexing engine 270 can create a ‘specialized’ index. The specialized index is a condensed form of a conventional index, and can be created based on topic shifts during a meeting. FIG. 3 illustrates a method (300) for creating such a specialized index. The indexing engine 270 first collects meeting data (305). Meeting data may be in the form of meta-data and can be defined by an endpoint user or a preset default.

Meeting data may include, without limitation, data extracted from a meeting invitation, such as content in the subject line or body of the invitation, or content in attachments to the invitation such as documents or links. Meeting data may include data extracted from content presented during the meeting. Meeting data may also include data about the participants to the meeting, which can be extracted from external sources (e.g., LinkedIn™ or similar social media channels), enterprise SME databases, or a historical record of previous meetings. Meeting data can further include, without limitation, the content of correspondence (e.g., email threads) between the participants of a meeting. In another embodiment, in the case of recurring meetings, meeting data may include historically recorded meeting notes or meta-data.

In one embodiment, meeting data is collected prior to, during, and/or after the meeting. For example, some environments support a meeting scheduling portal. Before the start of the meeting, the indexing engine 270 can collect the meeting data directly from the portal.

As meeting data is collected, the indexing engine 270 can transform that data into a textual record (310). For audio-based meeting data, the meeting data can be transformed to text using standard speech-to-text recognition techniques. For video or image-based meeting data, the system can apply standard OCR techniques to extract text. The text record is then used to create a starting index (315). For example, the starting index may include an alphabetized list of text words extracted from the textual record. In one embodiment, the indexing engine 270, or an analyzer 280 in the indexing engine 280, can create the starting index based on applying standard keyword recognition techniques to the textual record, such as whitelist/blacklist or stemming in order to eliminate words that have no value in an index or are not of interest. In another embodiment, the text record may be fed into a program like Solr™, which can retrieve stem words to build the starting index.

In another embodiment, because an endpoint carries out the initial indexing, meeting data pertaining to presentation content (e.g., presentation slides) can be extracted directly from the original version of the content stored at the relevant endpoint for higher indexing accuracy. For example, during a meeting EP B 220 may present a slide deck to EP A 210 through the server engine 200. The indexing engine 270 at EP B 220 can extract the slide deck content directly from the native slide deck (as opposed to extracting the content from video images of the slide deck). Extracting data directly from the native content guarantees higher accuracy in transforming content to text and thus higher accuracy in indexing the content.

In yet another embodiment, a module in the server engine 200, such as an indexing engine, can merge the starting indexes generated by endpoints to create a more finely tuned index. For example, in one embodiment EP B 220 shares a slide deck with EP A 210 via server engine 200. Both EP B 220 and EP A 210 create a starting index based on the slide deck. However, the starting index created by EP B 220 is based on the native slide deck file. The starting index created by EP A 210, on the other hand, is based on a video image of the slide deck. These starting indexes can be updated by the server engine 200 via index merging to obtain a more accurate index. For example, the server engine 200 may update the starting index in EP 210 to include the data derived from the native slide deck file from EP B 220, but exclude the data derived from the video image of the slide deck file from EP A 210. The server engine 200 can thereby update the starting indexes at both EP A 210 and EP B 220.

As meeting data is being collected and indexed by the indexing engine 270, the collaboration session can be recorded by the recording module 285. For example, the recording module 285 can record the video and/or audio data streams for the collaboration session for the duration of the meeting. At the same time, the server engine 200 can detect and track navigation events (320) at the endpoints. Navigation events indicate a participant's interest in a particular meeting topic. The server engine 200 tracks navigation events from both all participants, including the presenter. Navigation events may include, without limitation, mouse events, keyboard events, touch events, sharpening image events, page turns, image focusing, magnifying events, selection events, highlighting events, or any other event that indicates a participant's interest in the meeting topic. In one embodiment, for multiple content streams, magnifying or selecting one content stream can indicate a particular interest in the modified content stream. In still another embodiment, detecting and tracking navigation events can be performed at an end point. The data can then be transferred to the server engine 200 for further processing.

In another embodiment, a navigation event may include use of keywords through keyword spotting. For example, a user at an endpoint may use a keyword in an instant message. The server engine 200 can detect the instant message as a navigation event.

When a navigation event is detected, the server engine 200 (or the endpoint associated with the navigation event) then transforms the content or fragment of content (e.g., extract surrounding text) associated with the event into a textual record (325). This transformation necessarily depends on the type of content involved. For example, in one embodiment, for text-based content (e.g., instant messages, text documents), the content does not need to be transformed. In another embodiment, for audio-based content, the audio content can be transformed to text using standard speech-to-text recognition techniques. In another embodiment, for video or image-based content, the system can apply standard OCR techniques to extract text. The server engine 200 can then condense the text record based on standard keyword recognition techniques (330) such as whitelist/blacklist or stemming in order to eliminate words that have no value in an index or are not of interest.

Once an event is transformed to text, the server engine 200 then determines whether or not there has been a topic shift in the meeting (335). This is done by evaluating the transformed text against the starting indexes created by the endpoints. If the transformed text matches content in the starting index, the navigation event is considered a topic shift. If the server engine 200 does not identify a topic shift, then no further action is required. If the server engine 200 identifies a topic shift, however, the server engine 200 then updates the starting index at the endpoints to reflect the topical shift, associated keywords for the topical shift, and the time stamp for the topical shift 340. The process is repeated for each navigation event to further specialize the endpoint indexes, creating specialized indexes. In this way, the index can be sized to a reasonable number of keywords of interest for any given segment, which is comparable to existing command/control speech to text engines that have been proven to work reliably. In other words, the specialized index is a smaller more manageable type of index because it is created to reflect and is organized by topic shifts, which can eliminate false positives and irrelevant information found in conventional indexes.

In one embodiment, certain navigation events are not used to update the starting index. For example, the server engine 200 may transform audio content using speech-to-text, but will not update the specialized indexes to include such content. In another embodiment, the server engine 200 may transform video content using OCR techniques, but will not update the indexes to include such content. Narrowing the sources used to update the starting indexes improves accuracy and reduces then occurrence of false positives.

In an embodiment, all specialized indexes are stored in server engine 200 in the server's storage. These specialized indexes can later be retrieved and searched by any endpoint authorized to access the index.

In one embodiment, the server engine 200 can record a tuples for each topic shift. As an example, the tuple can take the form {timestamp, stemmed keyword/expression, pointer to original content, originator of event}. Pointer to original content may include a page or paragraph in a document, or highlighted text. An endpoint can process the tuples to create higher level indexes for the recorded meeting. In an embodiment, a higher level index can include something as simple as a keyword counter. In yet another embodiment, a higher level index can track a specific participant's affiliation for a given indexed topic. In still another embodiment, the tuples and high-level indexes are stored by server 200 for subsequent retrieval and searching.

The afore-mentioned embodiments provide a number of advantages over conventional systems. Redistributing indexing responsibilities from the server to the endpoints reduces the costs, latency, and overall load on the server, creating a highly scalable solution. Creating ‘specialized indexes’ based on topics also reduces the size of the index and provides for substantially higher indexing accuracy. A smaller more focused index is easier to search, requires less load to search, and is less likely to include false positives. Because the index is based on topics, a user can also quickly navigate directly to a topic of interest, bypassing parts of a recording that are of little or no interest. Specialized indexes can also be used to quickly and efficiently navigate large numbers of session recordings, such as in a global search. Finally, by indexing participants and meeting histories, the system can also identify and recommend experts on a particular topic to other participants in the system.

Many variations of the afore-mentioned systems are possible. For example, the indexing technology can be directly embodied as a product, such as software that can be installed on an endpoint and/or server engine to perform the indexing processes disclosed herein. Alternatively, the indexing technology can be embodied in a standalone endpoint device that can be used within a telephone or video conferencing architecture. In other embodiments, the indexing technology may be implemented as a service (which could be cloud-delivered). In such an embodiment, the recordings may be stored locally or in the cloud, while a cloud-based processor accesses the stored conversations and analyzes them to create the specialized indexes. Similarly, the specialized indexing technology could be incorporated into other software as a plugin, for use in a corporate document repository or social network system, for example.

It's understood that the above description is intended to be illustrative, and not restrictive. The material has been presented to enable any person skilled in the art to make and use the concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the embodiments herein therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of creating a specialized meeting index, comprising:
collecting meeting data associated with a meeting;
transforming the meeting data into a first textual record;
creating a first meeting index that is based on the first textual record;
recording a data stream associated with the meeting;
tracking one or more navigation events, the one or more navigation events indicating interest in a topic associated with the meeting;
transforming content from the data stream associated with the one or more navigation events into a second textual record;
comparing the first meeting index and the second textual record;
identifying a topic shift in the meeting based on a match between the first meeting index and the second textual record; and
updating, based on the identifying, the first meeting index to indicate the topic shift.

2. The method of claim 1, wherein the meeting data comprises at least one of data extracted from an invitation to the meeting, data extracted from content presented during the meeting, data associated with participants of the meeting, the content of correspondence between participants of the meeting, historically recorded meeting notes, and historically recorded metadata.

3. The method of claim 1, wherein collecting the meeting data associated with the meeting further comprises:
collecting the meeting data at least one of prior to the meeting, during the meeting, and after the meeting.

4. The method of claim 1, wherein collecting the meeting data associated with the meeting further comprises:
collecting the meeting data directly from native content stored at an endpoint.

5. The method of claim 1, wherein the one or more navigation events include one or more of mouse events, keyboard events, touch events, sharpening image events, page turns, image focusing, magnifying events, selection events, keyword events, and highlighting events.

6. The method of claim 1, wherein the updating the first meeting index to indicate the topic shift further comprises:
updating the first meeting index to indicate at least one of associated keywords for the topic shift, and a time stamp for the topic shift.

7. The method of claim 1, further comprising:
recording a tuples for the topic shift.

8. The method of claim 7, further comprising:
processing the tuples to generate a high level index for the meeting.

9. An endpoint system, comprising:
memory; and
one or more processors, the one or more processors communicatively coupled to the memory and configured to execute instructions stored in the memory to cause the endpoint system to:
collect meeting data associated with a meeting;
transform the meeting data into a first textual record;
create a first meeting index that is based on the first textual record;
record a data stream associated with the meeting;
detect one or more navigation events, the one or more navigation events indicating interest in a topic associated with the meeting; and
receive, from a server system, an update to the first meeting index that reflects topic shifts in the meeting, wherein the topic shifts are identified based on the one or more navigation events.

10. The endpoint system of claim 9, wherein the one or more processors are further configured to execute instructions stored in the memory to cause the endpoint system to:
transform content from the data streams associated with the one or more navigation events into a second textual record.

11. The endpoint system of claim 10, wherein the topic shifts are identified based on a match between the first meeting index and the second textual record.

12. The endpoint system of claim 9, wherein the meeting data comprises at least one of data extracted from an invitation to the meeting, data extracted from content presented during the meeting, data associated with participants of the meeting, the content of correspondence between participants of the meeting, historically recorded meeting notes, and historically recorded metadata.

13. The endpoint system of claim 9, wherein the one or more processors configured to execute instructions stored in the memory to cause the endpoint system to collect meeting data associated with the meeting are further configured to execute instructions to cause the endpoint system to collect the meeting data at least one of prior to the meeting, during the meeting, and after the meeting.

14. The endpoint system of claim 9, wherein the one or more processors configured to execute instructions stored in the memory to cause the endpoint system to collect meeting data associated with the meeting are further configured to execute instructions to cause the endpoint system to collect the meeting data from native content stored in the memory.

15. The endpoint system of claim 9, wherein the one or more navigation events include one or more of mouse events, keyboard events, touch events, sharpening image events, page turns, image focusing, magnifying events, selection events, keyword events, and highlighting events.

16. A server system, comprising:
memory; and
one or more processors, the one or more processors communicatively coupled to the memory and configured to execute instructions stored in the memory to cause the system to:
track one or more navigation events at a first endpoint, the one or more navigation events indicating interest in a topic associated with a meeting;
transform content from a data stream associated with the one or more navigation events into a first textual record;
compare the first textual record to a first meeting index stored in the first endpoint, wherein the first index is based on meeting data that is associated with the meeting;
identify a topic shift in the meeting based on a match between the first meeting index and the first textual record; and
update, based on the identifying, the first meeting index stored in the first endpoint to reflect the topic shift.

17. The server system of claim 1, wherein the one or more processors are further configured to execute instructions stored in the memory to cause the server system to:
receive, from the first endpoint, the first meeting index;
receive, from a second endpoint, a second meeting index, wherein the second index is based on meeting data associated with the meeting;
refine the first meeting index based on the second meeting index; and
send, after the refining, the first meeting index to the first endpoint.

18. The server system of claim 17, wherein the one or more processors configured to execute instructions stored in the memory to cause the server system to refine the first meeting index are further configured to execute instructions to cause the server system to:
substitute segments of the first meeting index that are not based on meeting data derived from native content with segments of the second meeting index that are based meeting data derived from native content.

19. The server system of claim 16, wherein the one or more processors are further configured to execute instructions stored in the memory to cause the server system to:
store, in the memory, the updated first meeting index.

20. The server system of claim 19, wherein the one or more processors are further configured to execute instructions stored in the memory to cause the server system to:
send, in response to a request from a second endpoint, the updated first meeting index to the second endpoint.

21. A method of creating a specialized meeting index, comprising:
collecting meeting data associated with a meeting;
tracking one or more navigation events, the one or more navigation events indicating interest in a topic associated with the meeting;
transforming the meeting data into one or more textual records associated with the one or more navigation events;
identifying one or more topic shifts in the one or more textual records; and
creating a meeting index that indicates the one or more topic shifts.
